(19) United States
(12) Patent Application Publication
(10) Pub. No.: US 2025/0108868 A1
(43) Pub. Date: Apr. 3, 2025

(54) TRAILER STEERING SYSTEM

(71) Applicant: Trail King Industries, Inc., Mitchell, SD (US)

(72) Inventor: Scot J. Vander Pol, Mitchell, SD (US)

(21) Appl. No.: 18/901,773

(22) Filed: Sep. 30, 2024

Related U.S. Application Data
(60) Provisional application No. 63/541,865, filed on Oct. 1, 2023.

(51) Int. Cl. B62D 53/06; B62D 21/20

(52) U.S. Cl. CPC B62D 53/06; B62D 21/20

(57) ABSTRACT

A trailer has an elongated body and a plurality of wheeled frames. The frames are pivotable with respect to the elongated body to move their wheels about a respective first vertical axis. Wheels on the frame are also pivotable about a second vertical axis so that movement of the wheels about the second vertical axis moves the wheels with respect to the frame.

### CROSS-REFERENCE TO RELATED APPLICATIONS

This application claims the benefit of U.S. Provisional Application No. 63/541,865, filed Oct. 1, 2023, entitled “Trailer Steering System.” The foregoing application is hereby relied upon and incorporated by reference herein in its entirety for all purposes.

### FIELD

One or more embodiments of the present disclosure relate generally to trailers having axle assemblies in which the wheeled trailer axles are rotatable with respect to the trailer frame and the wheel hubs are also pivotable with respect to the axles to which they are attached.

### BACKGROUND

The carriage of freight loads can require use of tractor-pulled trailers that are longer than standard, over-the-road semi-trailers, e.g., because the load's size requires the extended length or because the load's weight requires the use of a trailer with a greater number of wheeled axles in order to spread the per-axle load to a level within government requirements. It is known to include steering mechanisms with at least some of the axles on such trailers to facilitate tighter turns while reducing the likelihood that the trailer runs off the roadside at road intersection turns and reducing tire skid. In one arrangement, the trailer's wheeled axles are attached to the trailer frame by respective turntables so that the axle and its turntable do not rotate with respect to each other but so the turntable is attached to the trailer frame rotatably with respect to the frame about an axis that is vertical when the trailer rides on a flat surface. The axles are connected to linkages driven by the tractor unit's rotational position with respect to the trailer at the intersection of the trailer's king pin and the tractor unit's fifth wheel, such that as the tractor unit turns with respect to the trailer's longitudinal axis, the linkages push or pull the axles in predetermined manners so that the axles rotate with respect to the vertical axis as permitted by relative rotation between the turntable and the trailer frame. The wheel hubs rotate about an axis that is coaxial with the respective axles to which they attach and are not pivotable with respect to that axle axis in a horizontal plane. In other arrangements, the wheeled axles are attached non-rotationally to the trailer frame, but the wheel hubs are pivotable with respect to their respective axles so that the hubs' axes of rotation can be aligned coaxially with the axle axis or at selectable non-zero angles in a horizontal plane.

The present invention may recognize and address one or more considerations of prior art constructions and methods, as recited above or otherwise.

### BRIEF SUMMARY

One or more embodiments of a trailer in accordance with the present disclosure has an elongated body having a dimension of elongation, a forward end configured to connect to a tractor for pulling the trailer, and a rearward end opposite the forward end. A plurality of wheeled frames is attached to an underside of the elongated body. A plurality of wheels is attached to each wheeled frame of the plurality of wheeled frames. The plurality of wheeled frames each define an attachment to the elongated body that is pivotal about a first axis that is generally vertical so that relative rotation between a wheeled frame of the plurality of wheeled frames and the elongated body moves the plurality of wheels attached to that wheeled frame relative to the elongated body about the first axis. At each wheeled frame, a first wheel of the plurality of wheels attached to the wheeled frame is attached to the wheeled frame pivotably about a wheel axis that is generally vertical so that movement of the first wheel about the wheel axis moves the first wheel with respect to the wheeled frame of the plurality of wheeled frames.

In some embodiments, the first axis may be offset from the wheel axis. In some embodiments, each wheeled frame of the plurality of wheeled frames may include an axle that extends transverse to the dimension of elongation of the elongated body, and the axle may have a first distal end and a second distal end opposite the first distal end. Additionally, at least one first wheel is attached to the first distal end of the axle and at least one more first wheel is attached to the second distal end. Furthermore, in some embodiments, the axle may be a solid axle. Also, in some embodiments, at each wheeled frame of the plurality of wheeled frames, the first wheel(s) that are attached to the first distal end may be pivotably attached to the axle at the first distal end about a first wheel axis, and the first wheel(s) that are attached to the second distal end may be pivotably attached to the axle at the second distal end about a second said wheel axis.

In some embodiments, the elongated body may comprise at least one elongated beam. In some embodiments, the attachment may be a bearing between the elongated body and the frame.

In some embodiments, said each said frame may include a mechanical linkage attached to the elongated body and to said first wheel at the frame so that the mechanical linkage moves the first wheel about the wheel axis in response to relative movement of the frame and the elongated body about the first axis. Additionally, in some embodiments, the mechanical linkage may be attached to the elongated body and to each first wheel of a plurality of the first wheels attached to the frame. Also, in some embodiments, the mechanical linkage may include a first member, a second member, a third member, a fourth member, and an attachment member. One end of the first member may be attached to the elongated body and an opposite end of the first member may be attached to the attachment member. One end of the second member may be attached to the elongated body and an opposite end of the second member may be attached to the attachment member. One end of the third member may be attached to a first said first wheel and an opposite end of the third member may be attached to the attachment member. One end of the fourth member may be attached to a second said first wheel assembly and an opposite end of the fourth member may be attached to the attachment member.

In some embodiments, the trailer may also include a rigid member attached to a plurality of the frames so that movement of the rigid member in a direction in the dimension of elongation simultaneously rotates each of the plurality of frames with respect to the elongated body about said first axis. Additionally, in some embodiments, the rigid member may be attached to each of the plurality of frames at a position on the frame that is offset from the first axis of the frame, and the position on each said frame may be offset from its first axis by a distance that is different from the distance the position on each other frame of the plurality of frames is offset from the first axis of the frame.

One or more embodiments of a method of steering a trailer includes providing a trailer having an elongated body having a dimension of elongation, having a forward end configured to connect to a tractor for pulling the trailer and having a rearward end opposite the forward end. The trailer has a plurality of wheeled frames attached to an underside of the elongated body and, at each wheeled frame, a plurality of wheels attached to the wheeled frame, with each of the plurality of wheels including a first wheel. A wheeled frame of the plurality of wheeled frames is rotated relative to the elongated body about a first axis that is generally vertical so that the plurality of wheels moves relative to the elongated body about the first axis. At each said wheeled frame, each first wheel of the plurality of wheels attached to the wheeled frame is pivoted about a wheel axis that is generally vertical, so that movement of the first wheel about the wheel axis moves the first wheel with respect to the wheeled frame, simultaneously with the rotating of the wheeled frame relative to the elongated body.

One or more embodiments of a trailer in accordance with the present disclosure has a body, a plurality of axle assemblies attached to an underside of the body, and a plurality of wheels attached to each axle assembly of the plurality of axle assemblies. A first axle assembly of the plurality of axle assemblies comprises a first axle defining a longitudinal axis. The longitudinal axis of the first axle extends generally horizontally, and the first axle assembly permits rotation of the first axle relative to the body and about a generally vertical axle axis. A first wheel of the plurality of wheels attached to the first axle assembly is pivotably attached to the first axle, and the first wheel is rotatable relative to the first axle about a generally vertical wheel axis.

In some embodiments, the first axle assembly may include a mechanical linkage, and the mechanical linkage may be attached to the body and to the first wheel. Additionally, in some embodiments, the first axle assembly may be rotatable relative to the body, rotation of the first axle assembly may result in an identical amount of rotation of the first axle, and the rotation of the first axle assembly may result in an amount of rotation for the first wheel that is different relative to the amount of rotation for the first axle. Furthermore, in some embodiments, the rotation of the first axle assembly may result in the amount of rotation for the first wheel being larger than the amount of rotation for the first axle. In some embodiments, the first axle assembly may be rotatable relative to the body, and rotation of the first axle assembly relative to the body may cause movement of the mechanical linkage, thereby causing the first wheel to rotate about the wheel axis. Furthermore, in some embodiments, the mechanical linkage may include a first member, a second member, a third member, a fourth member, and an attachment member. One end of the first member may be attached to the body, and an opposite end of the first member may be attached to the attachment member. One end of the second member may be attached to the body, and an opposite end of the second member may be attached to the attachment member. One end of the third member may be attached to the first wheel, and an opposite end of the third member may be attached to the attachment member. One end of the fourth member may be attached to a second wheel, and an opposite end of the fourth member may be attached to the attachment member. In some embodiments, the axle may be a solid axle.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1A is a perspective view of a truck having a semi-trailer in accordance with an embodiment of the present invention;

FIG. 1B is a side view of the truck as illustrated in FIG. 1A, in accordance with an embodiment of the present invention;

FIG. 2A is a perspective view of a first group of axle assemblies in the truck illustrated in FIG. 1A, in accordance with an embodiment of the present invention;

FIG. 2B is a bottom view of the first group of axle assemblies illustrated in FIG. 2A where axles of the axle assemblies are illustrated as partially transparent, in accordance with an embodiment of the present invention;

FIG. 2C is a perspective view of a second group of axle assemblies in the truck illustrated in FIG. 1A, in accordance with an embodiment of the present invention;

FIG. 3A is a perspective view of the spine of the truck as illustrated in FIG. 1A when the trailer is turning in response to its tractor, in accordance with an embodiment of the present invention;

FIG. 3B is a top view of the spine of the truck as illustrated in FIG. 1A when the trailer is turning in response to its tractor, in accordance with an embodiment of the present invention;

FIG. 3C is a bottom view of the first group of axle assemblies in the truck illustrated in FIG. 1A when the trailer is turning in response to its tractor and where axles of the axle assemblies are illustrated as partially transparent, in accordance with an embodiment of the present invention;

FIG. 4A is a top perspective view of an individual axle assembly of the truck illustrated in FIG. 1A, in accordance with an embodiment of the present invention;

FIG. 4B is a bottom view of the axle assembly illustrated in FIG. 4A where an axle of the axle assembly is illustrated as partially transparent, in accordance with an embodiment of the present invention;

FIG. 4C is a bottom view of the axle assembly illustrated in FIG. 4A where the axle is fully visible, in accordance with an embodiment of the present invention;

FIG. 4D is a front view of the axle assembly illustrated in FIG. 4A where the axle of the axle assembly is partially transparent, in accordance with an embodiment of the present invention;

FIG. 4E is a bottom perspective view of the axle assembly illustrated in FIG. 4A where the axle is partially transparent, in accordance with an embodiment of the present invention;

FIG. 5A is a top perspective view of an individual axle assembly of the truck as in FIG. 1A, in accordance with an embodiment of the present invention;

FIG. 5B is a bottom view of the axle assembly illustrated in FIG. 5A where the axle of the axle assembly is partially transparent, in accordance with an embodiment of the present invention;

FIG. 5C is a front view of the axle assembly illustrated in FIG. 5A where the axle of the axle assembly is partially transparent, in accordance with an embodiment of the present invention;

FIG. 5D is a bottom perspective view of the axle assembly illustrated in FIG. 5A where the axle of the axle assembly is partially transparent, in accordance with an embodiment of the present invention; and

FIG. 6 is a box diagram illustrating various components of a steering assembly for a trailer as in FIG. 1A, in accordance with an embodiment of the present invention.

Repeat use of reference characters in the present specification and drawings is intended to represent same or analogous features or elements of the invention according to the disclosure.

### DETAILED DESCRIPTION

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present disclosure covers such modifications and variations as come within the scope of the appended claims and their equivalents. All values indicated below are intended to be approximated values.

It should be understood that terms of orientation, e.g., “forward,” “rearward,” “upper,” “lower,” and similar terms as used herein are intended to refer to relative orientation of components of the devices described herein with respect to each other under an assumption of a consistent point of reference but do not require any specific orientation of the overall system. Thus, for example, the discussion herein may refer to the “forward,” “rearward,” “lateral,” “side,” or similar descriptions, referring to areas of or directions with respect to a vehicle. Such terms may be used in the present disclosure and claims and will be understood to refer to a relative orientation but not to an orientation of a claimed device with respect to an external frame of reference unless expressly indicated.

Further, the term “or,” as used in this application and the appended claims, is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. The phrase “at least one of A and B” is satisfied by any of A alone, B alone, A and B alone, and A and B with others. The phrase “one of A and B” is satisfied by A, whether or not also in the presence of B, and by B, whether or not also in the presence of A. As used herein, the terms “pivot” and “rotate” have the same meaning.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

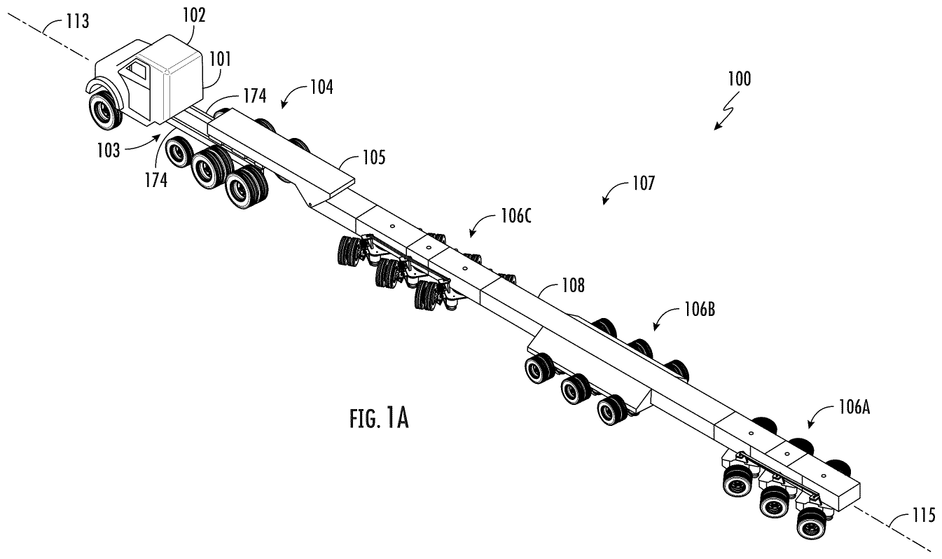

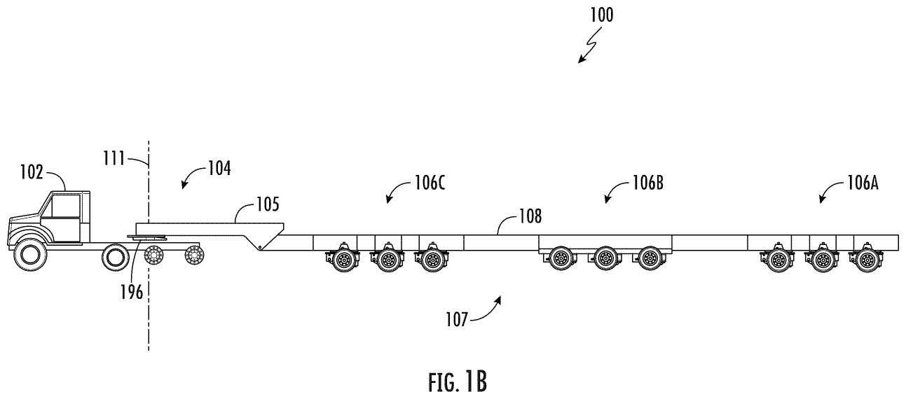

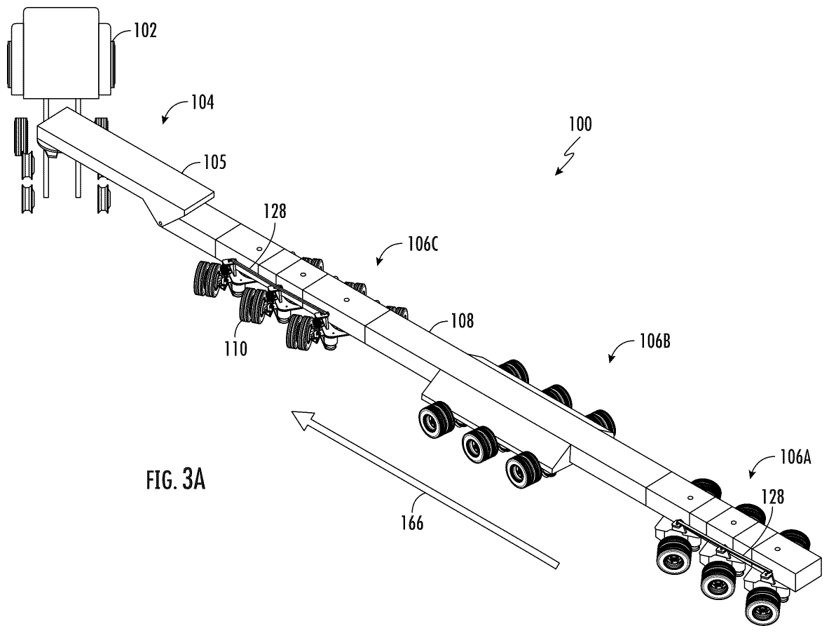

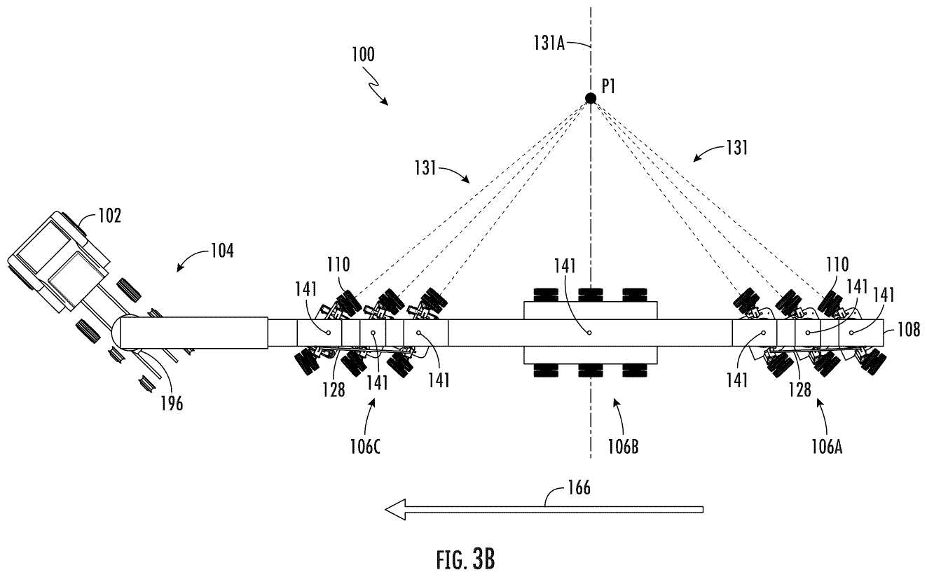

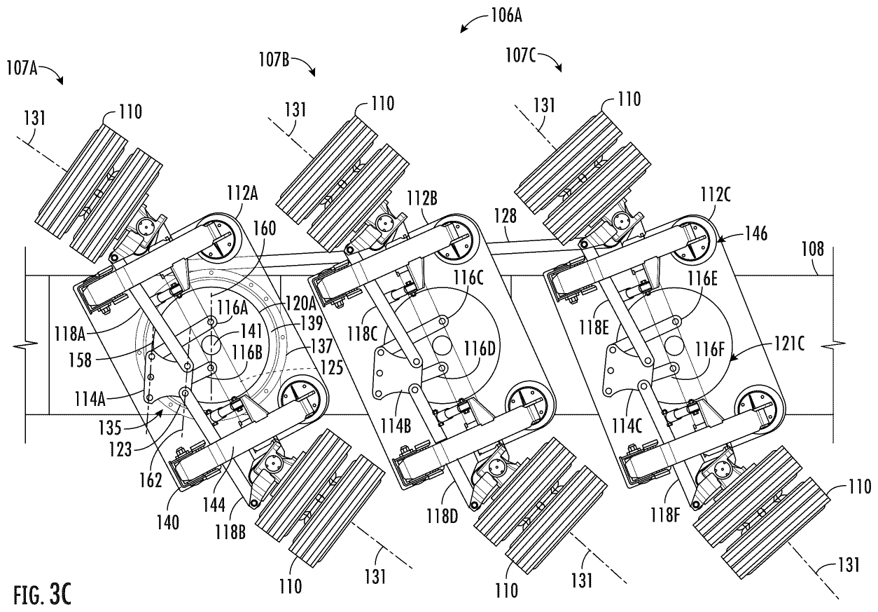

Referring to FIG. 1A, a semi-truck 100 has a tractor 102 with a housing that encloses a diesel engine or electric motor in an engine compartment forward of a driver cab 101. The engine is mounted on wheeled chassis 103 comprising a pair of elongated steel beams 174 that extend the length of tractor 102 and beneath which are suspended three wheeled axles that are elongated in a dimension transverse to the dimension of elongation of elongated frame rails 174. A fifth wheel 196 (FIGS. 1B and 3B) is mounted on the upper side of tractor frame rails 174, as should be understood.

Referring additionally to FIG. 1B, semi-truck 100 also comprises a trailer 107 having an elongated body, in this example an elongated spine 108 formed by a steel box beam, which may be made as a single, monolithic beam or as an assembly of discrete box beam sections. It should be understood that other body arrangements may be used, for example a single elongated I-beam, or a pair of parallel elongated I-beams, or a monocoque enclosure. A steel gooseneck beam 105, which may also be considered part of the trailer body, is attached to and extends forward from a forward end of spine beam 108. A kingpin (not shown) is welded to a coupler plate (not shown) that is attached to the forward underside of gooseneck beam 105 and extends downward therefrom to be received by fifth wheel 196 of tractor 102 to thereby secure trailer 107 to tractor 102 so that the tractor pulls trailer 107 when tractor 102 is driven forward. Thus, the forward end of the trailer may be considered that part of the trailer having the connection mechanism, in this example a kingpin, for the tractor. As should be understood, the trailer's kingpin is received by the tractor fifth wheel in an attachment that permits the kingpin to rotate about a vertical (in the perspective of FIG. 1B) axis 111. Thus, while FIG. 1A illustrates the dimension of elongation 113 of tractor 102 as aligned with the dimension of elongation 115 of the trailer 107's body, when a driver of tractor 102 controls the tractor's steering to turn the tractor to the left or right while driving the tractor forward, the pivotal coupling between the trailer kingpin and the tractor fifth wheel permits the tractor to turn with respect to the trailer, causing dimension 113 to form a non-zero angle with respect to dimension 115 as truck 100 executes the turn, as reflected herein.

A plurality of wheeled axle assemblies 106 are attached to the underside of spine beam 108. As illustrated in FIGS. 1A and 1, and in other Figures herein, axle assemblies 106 are offset with respect to each other but are spaced apart unevenly, so that there are multiple, in this instance three, distinct groups of axle assemblies that are proximate to each other as opposed to the axles of other groups. A first group of axle assemblies 106A are positioned at a rear end of spine beam 108, with a second group of axle assemblies 106B positioned forward on the spine beam from first group of axle assemblies 106A and a third group of axle assemblies 106C positioned forward on the beam from second group of axle assemblies 106B. Each of the three groups of axle assemblies includes three discrete axle assemblies. The trailer's rearward end may be considered that portion of the trailer to which the axle assemblies are attached.

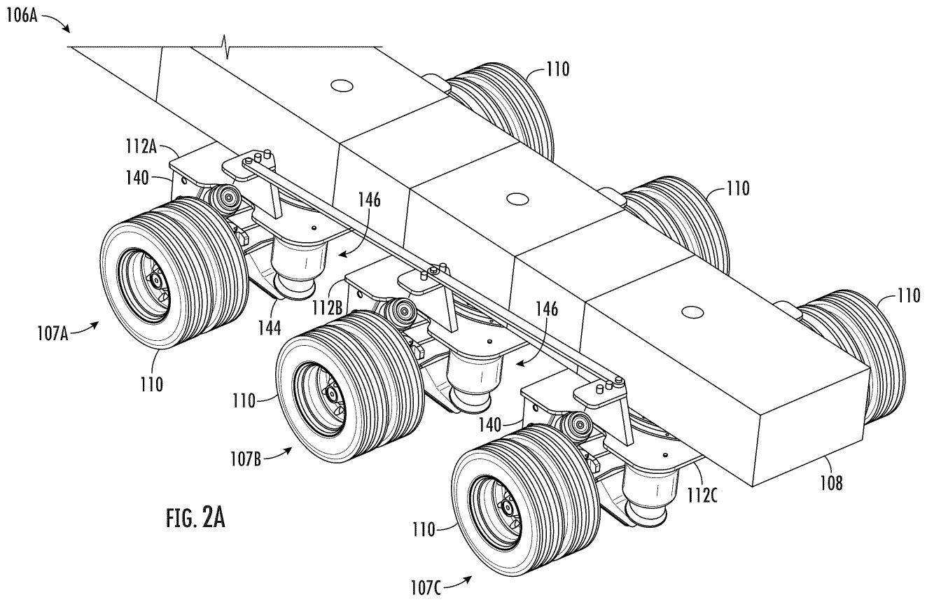

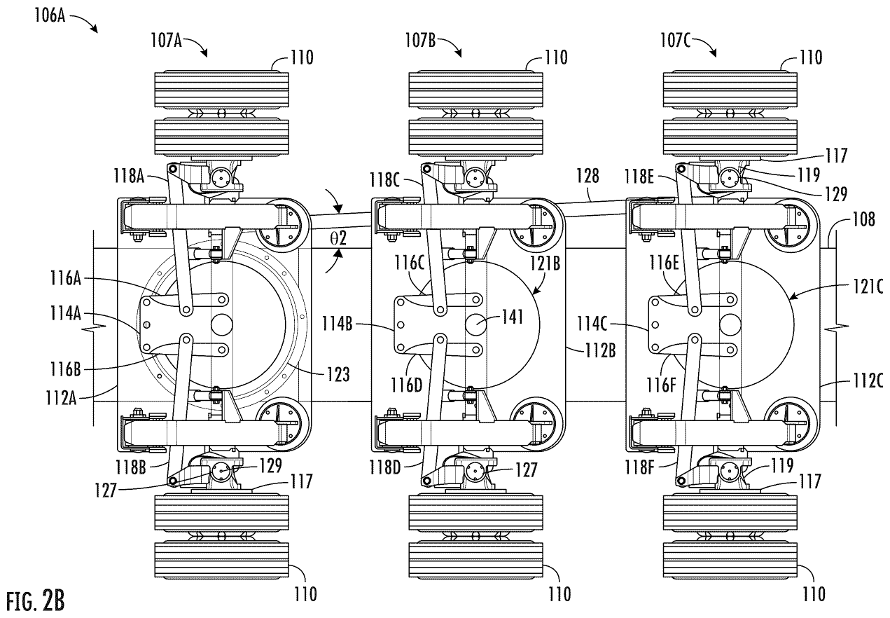

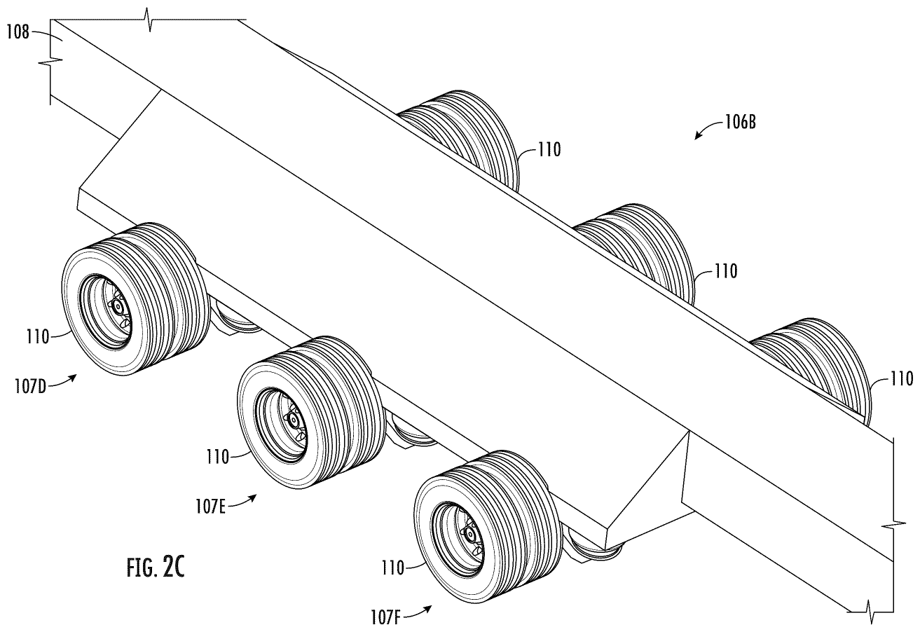

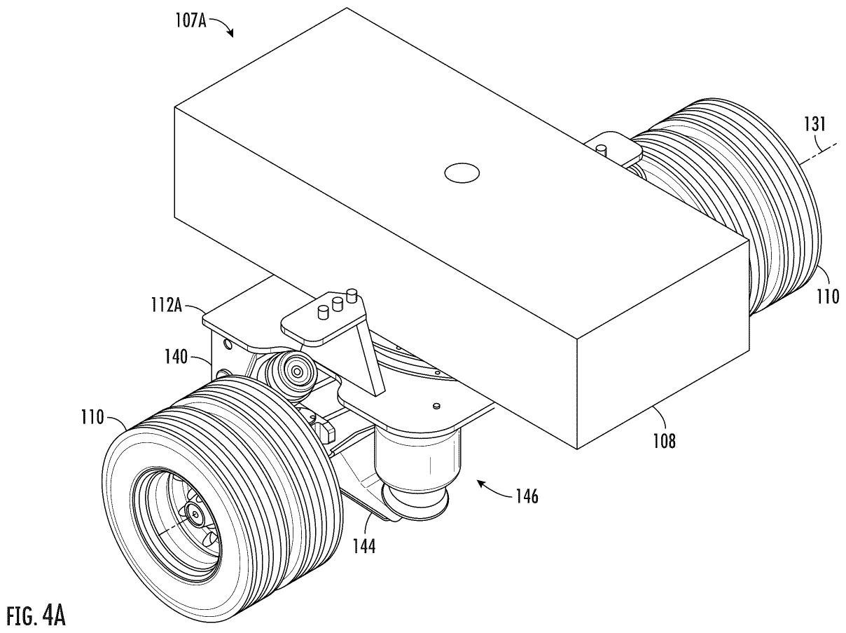

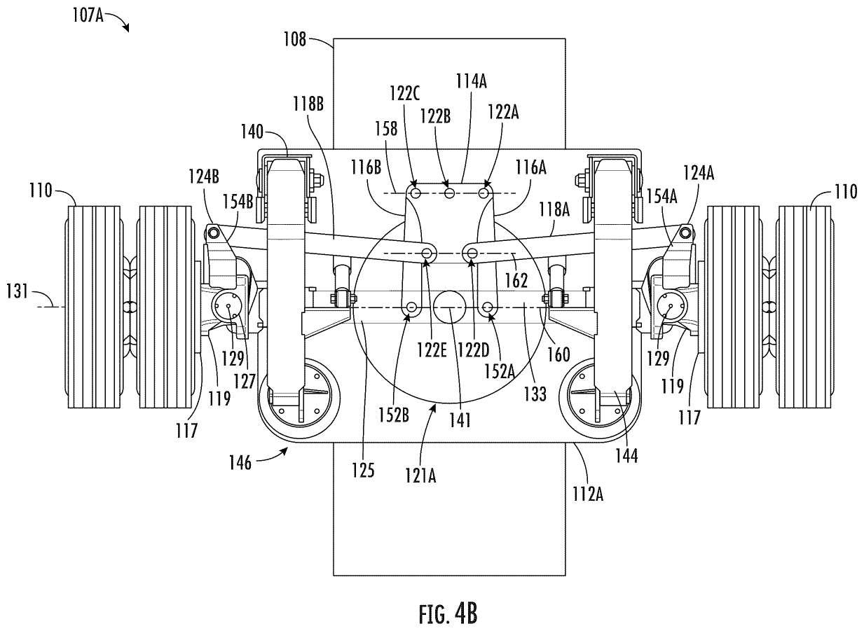

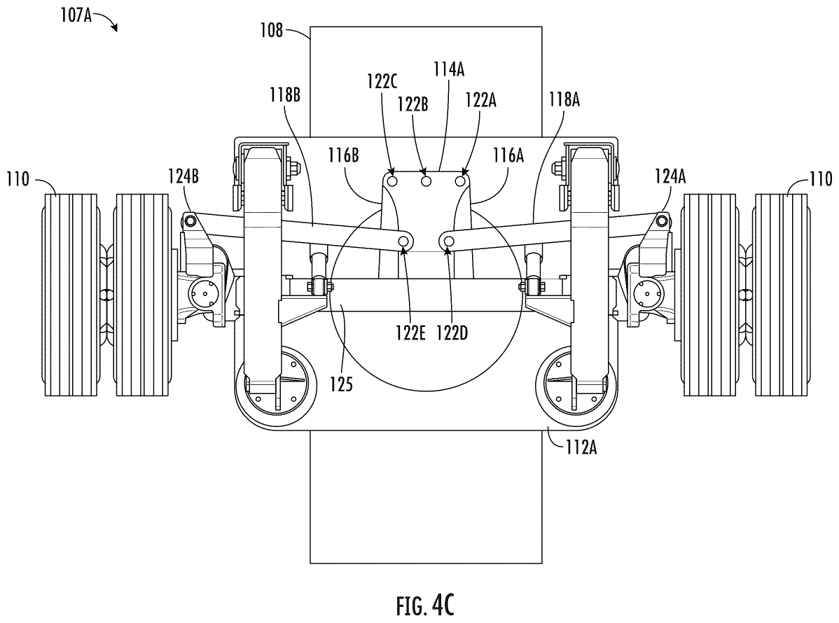

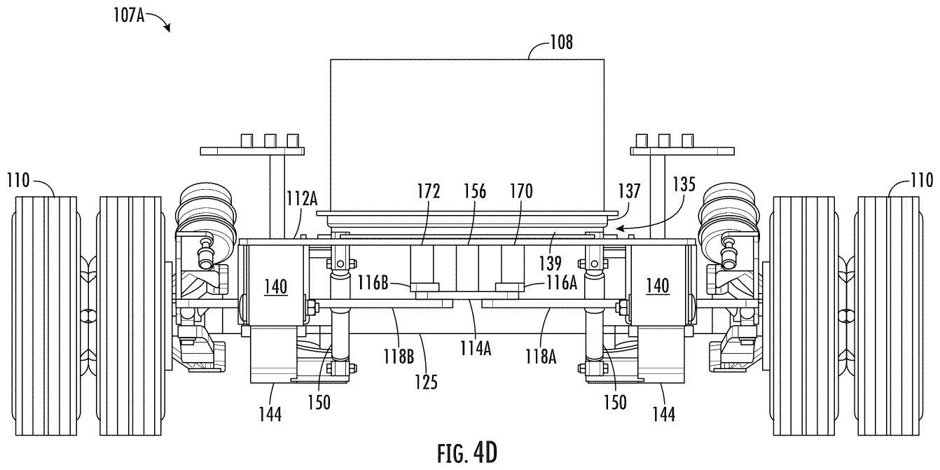

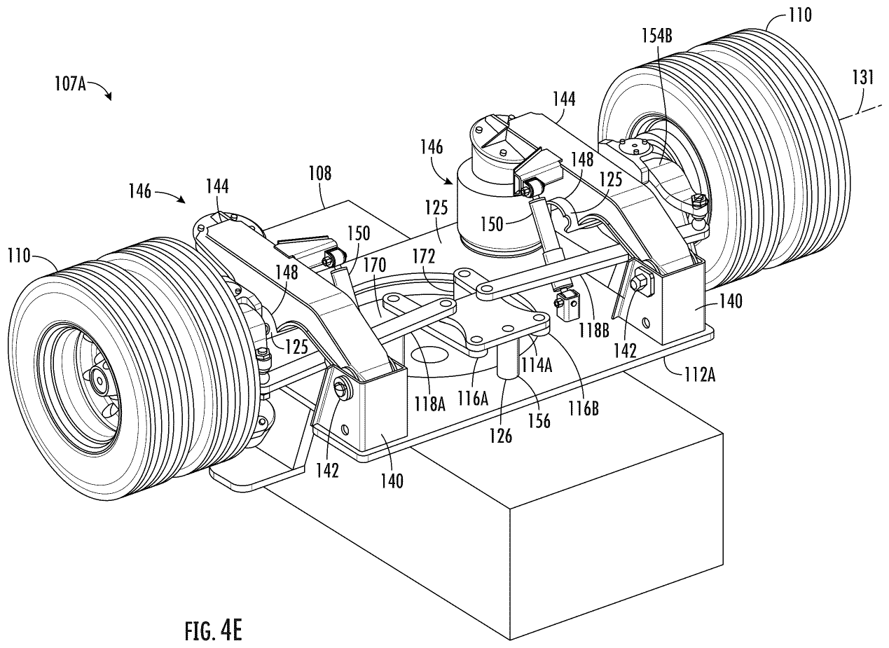

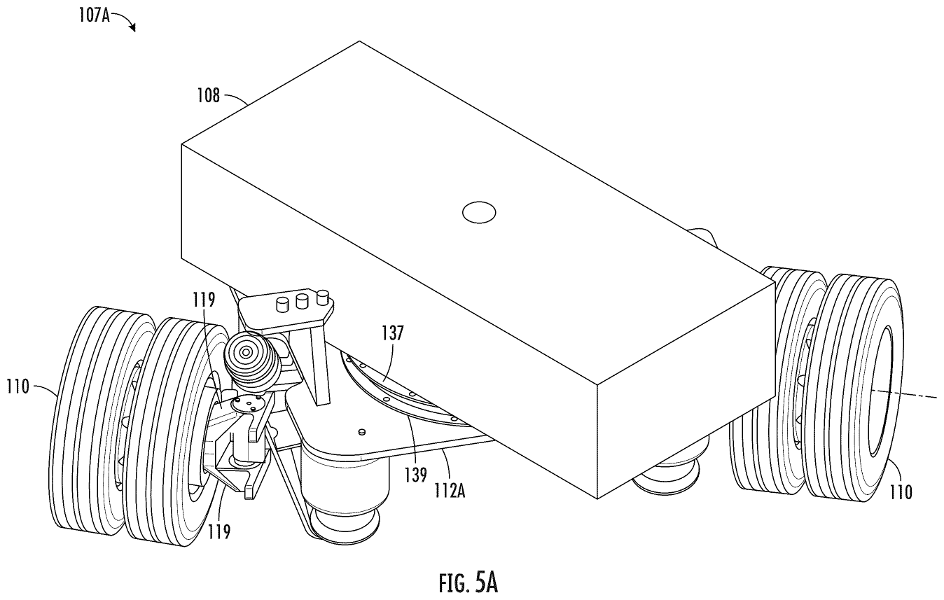

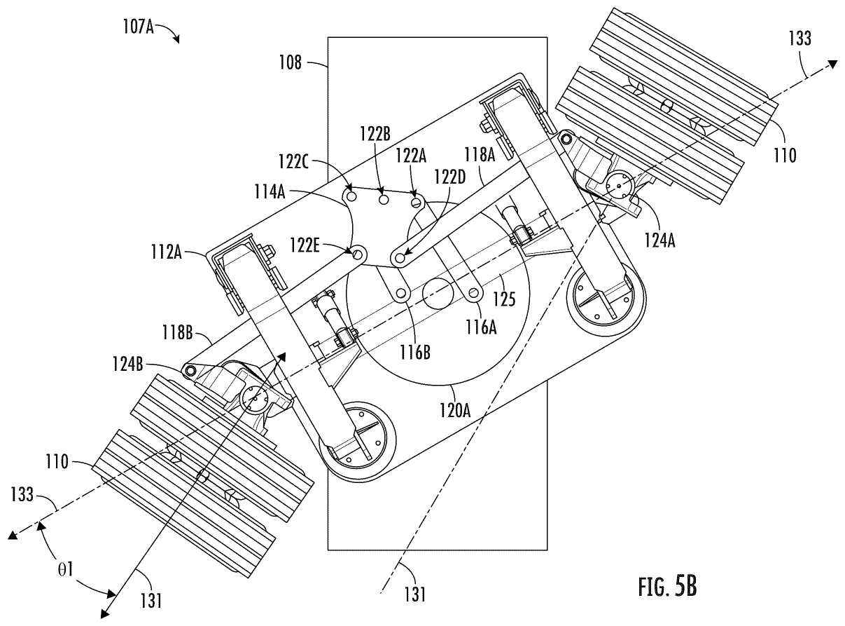

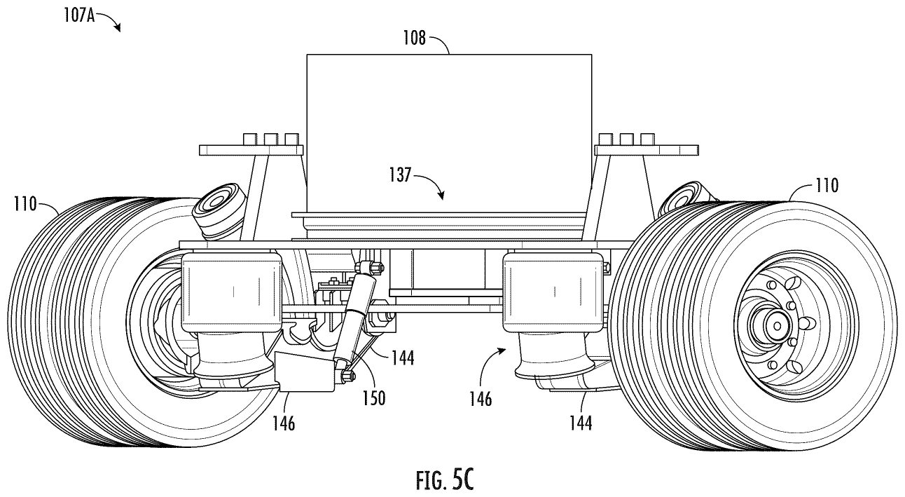

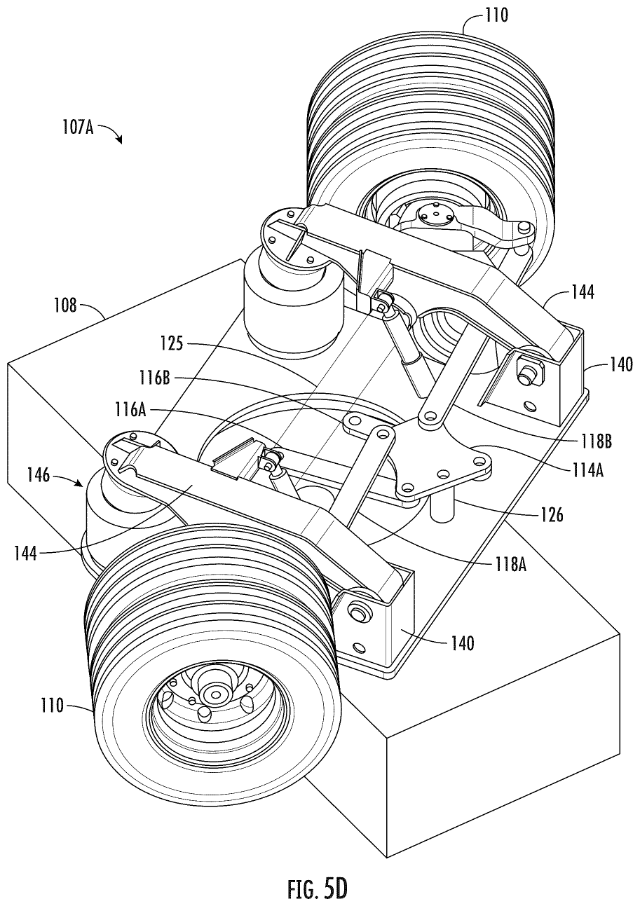

FIG. 2A is a perspective view of first group of axle assemblies 106A in trailer 100 illustrated in FIG. 1A, and FIG. 2B is a bottom view of first group of axle assemblies 106A. First group of axle assemblies 106A includes axle assemblies 107A-107C. Referring to FIGS. 2A and 2B, and also to FIGS. 4B, 4D, and 5A, each dual wheel/tire assembly is attached to a respective wheel hub 117 via lugs extending outward (away from spine beam 108) from the hub and received in corresponding holes through both wheels, as should be understood, to form a wheel/hub assembly 110. A central bore in each hub surrounds an elongated spindle (not shown) that is coaxial with the hub. One or more wheel bearing assemblies are disposed between the hub and the spindle to thereby allow each hub, and its corresponding dual wheel/tire, to rotate about the spindle as the trailer is pulled forward or pushed backward, when the tires engage a ground surface. Upper and lower arms 119 extend inward (toward beam 108) from the spindle, forming a yoke-shaped spindle bracket that aligns with corresponding bracket arms that are fixed to a solid axle 125 that extends transversely (with respect to the beam's dimension of elongation) across the underside of beam 108, at a distal end of the axle. The axles 125 are presented so that they are transparent in FIG. 2B. As should be understood, a solid axle is one that is continuously rigid across its length between opposing wheels. Thus, a solid axle may be formed, for example, from continuously rigid hollow tubing. In one or more examples, independent axles may instead be used in the axle assemblies. Cylindrical pins 127 extend through each adjoining spindle bracket arm/axle bracket arm pair. The spindle bracket and axle bracket are rotatable about the vertical axis 129 passing through the centers of the upper and lower pins 127 that connect the spindle bracket and the axle bracket, so that the axis of rotation 131 of each wheel/hub assembly 110 (and of the assembly's corresponding hub 117) is pivotable in a horizontal plane with respect to the solid axle's axis 133 about vertical axis 129 at the axle's distal end. As the wheel/hub assembly pivots about axis 129, the assembly, and, thus, its wheels, move with respect to the axle assembly frame. This arrangement is the same on each side of axle 125.

Each of the axle assemblies may include, and, in the illustrated embodiments, does include, a frame comprising a turntable, an axle, and a suspension between the turntable and the axle. The assembly includes a pair of wheels/tires on each side of the frame, and for example the axle, corresponding wheel hubs, and a pair of spindles that connect the hubs to the axle pivotally about respective vertical axes. The suspension components of each axle assembly 107A, 107B, and 107C also connect the axles, and thereby the wheels, to spine beam 108. For example, axle assembly 107A includes a turntable plate 112A that is attached to the underside of spine beam 108 rotatably about a vertical axis 141 (coming into and out of the page in the perspective of FIGS. 2B, 3B, 3C, and 4B) by a bearing 135 (FIGS. 3C, 4D, 5A, and 5C) composed of a lower race 139 bolted to turntable plate 112A, an upper race 137 bolted to the underside of spine beam 108, and a channel 123 defined between the races and in which ball (or other type) bearing elements are disposed. Bearing 135 thus retains turntable plate 112A on beam 108 in the vertical directions while allowing the turntable plate to rotate with respect to the spine beam about vertical axis 141 that passes through solid axle 125 and that defines the axis of rotation of turntable plate 112A. Thus, the axle assembly's frame is pivotal, with respect to the trailer body, about vertical axis 141. The frame's (e.g., when considering the axle's) rotation about axis 141 moves the wheels (and the wheel/hub assemblies) about axis 141 so that the wheels and wheel/hub assemblies may be considered to pivot/rotate about axis 141, regardless whether the wheel/hub assembly has the ability to pivot relative to the axle assembly frame as discussed herein. Turntable plate 112A may define a central through-hole 121A to accommodate air hoses, hydraulic lines, or electrical conduit, as the case may be, but in other embodiments the turntable plate does not have a through-hole for such purposes, and so hole 121A is omitted in such embodiments. Each of wheel assemblies 107B and 107C has the same construction, as indicated at 112B, 121B, 112C, and 121C.

The present discussion refers to several vertical axes. It should be understood that these references refer to a general vertical orientation, in that there will be variations from a perfect vertical due, e.g., to manufacturing and assembly tolerances, road surface variations, and the responsive operation of the suspension system. Similarly, references herein to horizontal orientation of planes and axes should be understood to refer to general horizontal orientation.

Referring also to FIGS. 4A, 4D, 4E, 5C, and 5D, a pair of suspension hangers 140 are fixed (e.g., by welding) to the underside of turntable plate 112A. Each suspension hanger 140 is three-sided, with a through hole passing through the lower ends of the two side walls of each suspension hanger through which a cylindrical pin 142 passes. Each pin 142 also passes through corresponding holes through one end of a trailing arm 144 so that each trailing arm is pivotable about the cylindrical axis of its cylindrical pin 142 and, therefore, is pivotable about that axis with respect to its suspension hanger, plate 112A, and beam 108. At its opposite end, each trailing arm is attached to one end of an air bag suspension assembly 146. On its upper side, generally in the center thereof, each trailing arm defines a partial cylindrical depression 148 having a radius of curvature that matches the outer cross-sectional radius of curvature of solid axle 125 and that receives axle 125 therein. Axle 125 is secured, for example by welding, to the trailing arm at this trailing arm depression. Accordingly, as each pair of wheels 110 engages bumps or dips in a roadway surface, the vertical forces applied to the wheel from such engagement translate to trailing arms 144, causing the trailer arms to pivot about the axes of pins 142 and allowing the wheels to move vertically with respect to the turntable plate and spine beam 108, though such movement is cushioned by air ride systems 144 and by shock absorbers 150 attached at one end thereof to turntable plate 112A and at the other end to trailing arm 144. Axle assemblies 107B and 107C are similarly constructed.

Each axle assembly includes a hub steering assembly that is generally comprised of a bar linkage that extends between the two opposing wheel hubs at the two ends of the solid axle, at opposing outer ends of the linkage, and spine beam 108 (via bearing 135), at the inner ends of the linkage. Referring to FIGS. 2B, 3C, and 4E, with regard to axle assembly 107A, the hub steering assembly includes a central control member 114A and elongated force members 116A, 116B, 118A, and 118B. Central control member 114A, as illustrated, comprises a generally trapezoidal shape with diagonal sides of the trapezoidal shape being curved, but the central control member may be formed of other shapes in other embodiments, as is apparent from the discussion below. Central control member 114A is, in the illustrated embodiments, provided in the form of a rigid metal, such as steel, plate but may possess other forms and may comprise different materials in other embodiments. Each of elongated force members 116A, 116B, 118A, 118B is rigid and may be provided in the form of a metal, such as steel, bar or an adjustable rod (that allows adjustment of the rod's length, thereby allowing adjustment of the hub steering assembly's operation), though force members 116A, 116B, 118A, and 118B may comprise other materials in some embodiments.

Referring also to FIG. 4B, central control member 114A defines five cylindrical through holes (with vertical axes, coming into and out of the page in the perspective of FIG. 4B) 122A, 122B, 122C, 122D, and 122E. A first end of end of force member 116A defines a through hole at one end thereof that has a diameter that is the same as the diameter of through hole 122A and that is aligned with through hole 122A. A cylindrical pin is received in the two through holes to connect this end of force member 116A to the illustrated corner of central control plate 114A so that force member 116A and central control plate 114A are pivotal with respect to each other about the central vertical axis (into and out of the page in the perspective of FIG. 4B) of the pin. The opposing end of force member 116A defines a through hole 152A also having a vertical axis and that receives therein a cylindrical lug fixed to an end of and extending downward from a cylinder 170 (FIGS. 4D and 4E) that is welded to and extends downward from the generally planar bottom surface of spine beam 108 so that the axis of the cylindrical lug is coaxial with through hole 152A. Through hole 152A receives the lug so that force member 116A seats on cylinder 170 and is pivotable about the vertical axis of through hole 152A with respect to the lug and spine beam 108.

A first end of end of force member 116B defines a through hole at one end thereof that has a diameter that is the same as the diameter of through hole 122C and that is aligned with through hole 122C. A cylindrical pin is received in the two through holes to connect this end of force member 116B to the illustrated corner of central control plate 114A so that force member 116B and central control plate 114A are pivotal with respect to each other about the central vertical axis (into and out of the page in the perspective of FIG. 4B) of the pin. The opposing end of force member 116B defines a through hole 152B also having a vertical axis and that receives therein a cylindrical lug fixed to an end of and extending downward from a cylinder 172 (FIGS. 4D and 4E) that is welded to and extends downward from the generally planar bottom surface of spine beam 108 so that the axis of the cylindrical lug is coaxial with through hole 152B. Through hole 152B receives the lug so that force member 116B seats on cylinder 172 and is pivotable about the vertical axis of through hole 152B with respect to the lug and spine beam 108.

A first end of end of force member 118A defines a through hole at one end thereof that has a diameter that is the same as the diameter of through hole 122D and that is aligned with through hole 122D. A cylindrical pin is received in the two through holes to connect this end of force member 118A to the illustrated corner of central control member 114A so that force member 118A and central control member 114A are pivotal with respect to each other about the central vertical axis (into and out of the page in the perspective of FIG. 4B) of the pin. The opposing end 124A of force member 118A is connected by a ball joint (to accommodate vertical travel of the suspension) the distal end of a control arm bracket 154A that is fixed to and extends from the spindle bracket. Bracket 154A and force member 118A are thereby pivotable with respect to each other about a vertical axis (and other dimensions, due to the ball joint) passing through the ball joint with respect to spine beam 108.

A first end of end of force member 118B defines a through hole at one end thereof that has a diameter that is the same as the diameter of through hole 122E and that is aligned with through hole 122E. A cylindrical pin is received in the two through holes to connect this end of force member 118B to the illustrated corner of central control member or plate 114A so that force member 118B and central control member 114A are pivotal with respect to each other about the central vertical axis (into and out of the page in the perspective of FIG. 4B) of the pin. The opposing end 124B is connected by a ball joint (to accommodate vertical travel of the suspension) to the distal end of a control arm bracket 154B that is fixed to and extends from the spindle bracket. Bracket 154B and force member 118B are thereby pivotable with respect to each other about a vertical axis (and other dimensions, due to the ball joint) passing through the ball joint with respect to spine beam 108.

A cylindrical pin 156 is fixed (e.g., by welding) to the bottom surface of turntable 112A at 126. A through hole 122B having a vertical axis extends through a center of the edge of central control member 114A through which through holes 122A and 122C are disposed such that the vertical axes of through holes 122A, 122B, and 122C are parallel to each other and generally perpendicularly cross a common line 158. A generally cylindrical lug is fixed to and extends downward from the distal (away from spine beam 108) end of cylindrical pin 156 extends into and through the through hole 122B so that the pin attaches central control member 114A to center guide 120 so that central control member 114A is pivotable about the axis of the lug and through hole 122B (which is parallel to axis 141) with respect to spine beam 108.

The vertical axes of through holes 152A and 152B, and vertical axis 141, are generally parallel to each other and generally perpendicular to a common line 160 (FIG. 3C) that passes through all three such vertical axes. Because positions 152A and 152B are fixed to spine beam 108 (though force members 116A and 116B may pivot about those positions), line 160 remains stationary regardless of the rotation of turntable plate 112A with respect to spine beam 108 about axis 141. Further, because force members 116A and 116B are the same length, and because position 122B is fixed to turntable 112A along line 158 by pin 156 while the pins at positions 152A and 152B hold force members 116A and 116B in position along line 160 with respect to spine beam 108, central control member 114A pivots, as the turntable turns about axis 141, about the vertical axis through position 122B in a direction of rotation opposite to the turntable's direction of rotation (thus, if the turntable turns counterclockwise about axis 141, central control member 114A pivots clockwise about the vertical axis through position 122(B)) so that line 158 skews away from being parallel to line 160 as the turntable and the central control member rotate. Due to the placement of positions 122D and 122E such that a line 162 through and generally perpendicular to the vertical axes of through holes 122D and 122E is generally parallel to line 158 as turntable 112A rotates about axis 141 with respect to spine beam 108 and central control member 114A rotates about the vertical axis through position 122B.

Referring to FIGS. 3C and 4B, as turntable 112A rotates about axis 141 counterclockwise (in the bottom view perspective of FIGS. 3C and 4B) from its position shown in FIG. 4B (in which line 160 is aligned with solid axle axis 133, in which lines 158, 160, and 162 are all parallel to each other and to solid axle axis 133, and in which position 122B is fixed to the rotating turntable), the connection of the control member to the spine beam by force members 116A and 116B, and the connection of control member 114A to the turntable by pin 156, means that central control member 114A rotates clockwise about the axis of through hole 122B. This causes central control member 114A to pull force member 118A inward toward the center of spine beam 108 and to push force member 118B outward away from the center of spine beam 108, thereby pivoting the upper (in the perspective of FIGS. 3C and 4B) wheel/hub assembly 110 counterclockwise about the vertical axis 129 passing through the pins between the spindle bracket and the axle bracket that connect upper wheel/hub assembly 110 to the upper (in the perspective of FIGS. 3C and 4B) end of solid axle 125, and thereby pivoting the lower (in the perspective of FIGS. 3C and 4B) wheel/hub assembly 110 counterclockwise about the vertical axis 129 passing through the pins between the spindle bracket and the axle bracket that connect lower wheel/hub assembly 110 to the lower (in the perspective of FIGS. 3C and 4B) end of solid axle 125. Force members 118A and 118B are of the same length in their dimensions of elongation. However, the distance along line 160 between the vertical axes of through holes 152A and 152B is greater than the distance along line 158 between the vertical axes through pins through 122A and 122C. As a result, central control member 114A pivots at a greater angular rotation than does turntable 112A when turntable 112A drives the central control member's rotation.

The hub steering assembly's pivoting of the wheel/hub assemblies with respect to the solid axle about vertical axes 129 pivots each of the wheel/hub assembly's rotational axis 131 with respect to solid axle 125's axis 133 in a horizontal plane by a non-zero angle θ1, as shown in FIG. 5B. In one or more embodiments, due to the geometries of center guide 120A, turntable 112A, central control member 114A, force members 116A, 116B, 118A, and 118B, and of the wheel/hub assemblies, the hub steering assembly of axle assembly 107A pivots the two wheel/hub assemblies at opposite ends of the same axle with respect to the solid axle's axis of elongation 133 by a slightly different angular rotation θ1, depending whether the wheel/hub assembly is on the inboard side of the trailer during its turn or on the outboard side. In these examples, angular rotation θ1 for the wheel/hub assembly on the trailer's outboard side during a turn is slightly less than angular rotation θ1 on the trailer's inboard side of the turn, such that the axes 131 of both wheel/hub assemblies on opposite distal ends of the axle converge at point P1 as shown at FIG. 3B. It should be understood, however, that the present disclosure encompasses other arrangements, e.g. where angular rotation θ1 is the same for the two wheel/hub assemblies attached to either end of the axle and the axes of rotation 131 for those two wheel/hub assemblies remain either coaxial with each other (see FIG. 4B) or otherwise in parallel (see FIG. 5B) over the range of rotation of axle 125 (and, thus, turntable 112A) with respect to spine beam 108 about vertical axis 141.

As apparent from the discussion above, axle 125 pivots about vertical axis 141 with the turntable's rotation about axis 141, such that the axle's axis of elongation 133 remains parallel to an axis that bisects the turntable parallel to the turntable's long side edges in the embodiment illustrated in FIGS. 3C and 4B. Thus, axle 125 and turntable 112A are fixed to each other with respect to rotation about that vertical axis even though axle 125 may travel vertically to some degree with respect to the turntable under the control of the air-ride system and shock absorbers, as discussed above. Accordingly, force applied to axle 125 tangential to axis 141 sufficient to overcome internal frictions rotates both axle 125 and turntable 112A about axis 141, together. In the absence of the hub steering assembly, and assuming the wheel/hub assemblies were attached to the ends of axle 125 so that the wheel/hub assemblies do not pivot about axes 129, such rotation of the axle and the turntable about vertical axis 141 would turn wheel/hub assemblies 110 only with the axle's rotation, moving the wheel/hub assemblies about the axle assembly frame's rotation axis 141 such that wheel/hub rotation axes 131 would remain aligned with axle axis 133. Because the hub steering assembly integrates the turntable's rotation into additional rotation of the wheel/hub axes 131 (about the respective axes 129 with respect to the axle assembly frame), however, the wheel/hub assemblies turn to a greater degree, additionally pivoting in the same rotational direction as the turntable's rotational direction (i.e., if the turntable pivots counterclockwise, the hub steering assembly additionally pivots each wheel/hub assembly counterclockwise about its axis 129, and vice versa) by the relative angular rotation θ1 (FIG. 5B) between wheel/hub axes 131 and axle axis 133. Axle assemblies 107B and 107C have the same arrangement, including with respect to their hub steering assemblies, and operate in the same manner as described herein with respect to axle assembly 107A.

Referring to FIGS. 2B, 3B, 3C, and 5B, an elongated control bar 128 applies the tangential force discussed above to axles 125 of axle assemblies 107A-107C to rotate those axles about their respective vertical axes 141. As illustrated in FIG. 2B, control bar 128 is attached to each of the three axles 125 of axle assemblies 107A-107B (e.g., by three cylindrical pins that extend through bar 128 and a respective axle 125 so that control bar 128 is rotatable with respect to each axle axis 133 about the respective pins) so that when the three axles 125 are aligned so that their axes 133 are parallel to each other, and perpendicular to the axis of elongation of elongated spine beam 108, and thus so that the wheel/hub assembly axes 131 are aligned with axes 133, control bar 128 is disposed so that its dimension of elongation is oriented at a non-zero acute angle θ2 with respect to the dimension of elongation of spine beam 108. To achieve angle θ2 in one or more embodiments, control bar 128 attached to the three axles 125 at different points on the axles, and in particular at different points along each axle's axis 133. Control bar 128 attaches to axle 125 of axle assembly 107A at a point along the axle's axis 133 that is closer to spine beam 108 and vertical axis 141 (and further from the wheel hub) than the respective points at which control bar 128 attaches to the other two axles. Control bar 128 attaches to axle 125 of axle assembly 107C at a point along the axle's axis 133 that is further from spine beam 108 and the axle assembly's vertical axis 141 (and closer to the wheel hub) than the respective points at which control bar 128 attaches to the other two axles. Control bar 128 attaches to axle 125 of axle assembly 107B at a point along the axle's axis 133 that is, in one or more embodiments, midway between the point on its axle axis 133 at which the axle of axle assembly 107A attaches to bar 128 and the point on its axle axis 133 at which the axle of axle assembly 107C attaches to bar 128. Thus, when a force vector in either direction in the dimension of elongation of spine beam 108 (i.e., left or right in the perspective of FIG. 2B) moves control bar 128 in such direction, that movement applies force to all three axles of axle assemblies 107A-107C, so that the three axles 125 simultaneously rotate respectively about their vertical axes 141, but due to the differing attachment points of control bar 128 to the three axles, axle 125 of axle assembly 107A moves a greater angular rotation about its axis 141 than does either of the axles of axle assemblies 107B and 107C, and axle 125 of axle assembly 107C moves a lesser angular rotation than does either of axle assemblies 107A and 107B, while axle 125 of axle assembly 107B moves an angular rotation about its axis 141 that is midway between the angular rotations of the axles of axle assemblies 107A and 107C. Correspondingly, the hub steering assembly of axle assembly 107A pivots the wheel/hub assemblies 110 of axle assembly 107A by a larger angular rotation than the respective angular rotations of the wheel/hub assemblies 110 of axle assemblies 107B and 107C, while the hub steering assembly of axle assembly 107C pivots the wheel/hub assemblies 110 of axle assembly 107C by a lesser angular rotation than the respective angular rotations of the wheel/hub assemblies 110 of axle assemblies 107A and 107C, while the hub steering assembly of axle assembly 107B pivots the wheel/hub assemblies 110 of axle assembly 107B by an angular rotation that is midway between the wheel/hub angular rotations of axle assemblies 107A and 107C. Thus, the angles θ1 of the wheel/hub assemblies 110 of axle assembly 107A>the corresponding angles θ1 of the wheel/hub assemblies 110 of axle assembly 107B>the corresponding angles θ1 of the wheel/hub assemblies 110 of axle assembly 107C. FIGS. 3B and 3C illustrate this effect. Accordingly, the attachment of axle assemblies 107A-107C to each other by control bar 128 allows for axle assemblies 107A-107C to rotate, both in terms of angular displacement of the axles about their vertical axes 141 and the angular displacement of the hubs about their vertical axes 129, in controlled amounts relative to each other. In some embodiments, bar 128 may be configured to cause axle assemblies 107A-107C to rotate in identical amounts. However, in other embodiments, such as illustrated in the Figures, bar 128 may be configured to cause axle assemblies 107A-107C to rotate in differing amounts.

Referring also to FIGS. 1A, 1, and 3A, in one or more embodiments, movement of control bar 128 is controlled in response to turning of tractor 102 with respect to trailer 107 about fifth wheel/king pin axis 111, so that the tractor's dimension of elongation 113 and the trailer body's dimension of elongation 115 relatively rotate with respect to each other about axis 111. In some embodiments, for example, a mechanical linkage is pivotally attached to the underside of gooseneck beam 105, at axis 111. The linkage engages fifth wheel 196 so that, if tractor 102 turns to the right (from the perspective looking forward toward the front of trailer 107, as indicated at arrow 166 in FIG. 3A), as indicated in FIG. 3A, the fifth wheel rotates the pivotal linkage so that a left side of the linkage rotates forward in direction 166, while a right side of the linkage rotates rearward, opposite direction 166. The linkage left side is mechanically connected through one or more cables or bars to control bar 128 of axle assembly group 106C, pulling or pushing the control bar forward in direction 166 so that the three axles 125 in axle assembly group 106C rotate to the right (i.e., clockwise, in the top-down perspective of FIG. 3A) about their axes 141. Conversely, the linkage right side is mechanically connected through one or more cables or bars (or, e.g., hydraulically connected via a master-slave cylinder arrangement) to control bar 128 of axle assembly group 106A, pulling or pushing the control bar rearward, opposite direction 166, so that the three axles 125 in axle assembly group 106A rotate to the left (i.e., counterclockwise, in the top-down perspective of FIG. 3A) about their axes 141. If tractor 102 turns to the left (in the perspective of FIG. 3A), fifth wheel 196 drives the linkage at axis 111 to rotate in the opposite direction, thereby driving the axles of axle assembly group 106C to rotate in the counterclockwise direction and the axles of axle assembly group 106A to rotate in the clockwise direction, again in the top view perspective of FIG. 3A. Thus, axle assembly group 106C turns in the same rotational direction as tractor 102 turns, while axle group 106A turns in the rotational direction opposite to the direction tractor 102 turns. Each of the axle assemblies in each of axle assembly groups 106C and 106A are constructed with the integrated turntable steering and hub steering assemblies as discussed above, so that each of the wheel/hub assemblies 110 thereof increases its rotation by angle θ1 (the degree of which, as discussed above, depends on which way the tractor turns, thereby making one side of the trailer the inboard side or the outboard side) with respect to its vertical axis 129 over the more general rotation about its axle's vertical axis of rotation 141 alone. Referring also to FIG. 2C, the three axles 125 of axle assemblies 107D, 107E, and 107F of axle assembly group 106B, in the illustrated example, have neither turntable steering nor hub steering. The wheel/hub assemblies of this axle assembly group rotate about their axes 131 in a fixed alignment with the respective axes 133 of their solid axles. It should be understood in view of the present disclosure, however, that, in other embodiments, axle assembly group 106B may also be provided with steering, including with integrated turntable and hub steering.

The action of forward axle assembly group 106C, in that it turns with the tractor turn direction, and of rearward axle assembly group 106A, in that it turns opposite the tractor turn direction, facilitates a tighter turn of trailer 107 than would occur if all three axle assembly groups were non-steerable. In that regard in one or more embodiments, and referring again to FIG. 3B but also to FIGS. 1A, 1B, 2B, 3A, 3B, and 5B, the control bar 128 of the forward axle assembly group 106C is attached to the group's axles 125 so that the forwardmost axle (in the perspective of direction 166) connects to that bar 128 at the point closest (among the connection points between bar 128 and the axles of group 106C) to spine beam 108 and the corresponding axis 141, while the rearward-most axle in group 106C connects to bar 128 at the point furthest (among the connection points between bar 128 and the axles) to spine beam 108 and the corresponding axis 141, and while bar 128 of rear axle assembly group 106A attaches to its group's axles in the opposite orientation. The non-zero acute angles θ2 for the two axle groups, between the dimensions of elongation of bar 128 and spine beam 108, are the same but, due to this opposing orientation of the bars 128, are 180° offset with respect to each other, so that the respective gaps between the control bars and spine beam edge plane open toward each other, as illustrated in FIG. 3B. Thus, as will be understood from the discussion above, the wheel/hub assemblies 110 of the forwardmost axle 125 in axle assembly group 106C pivot about their respective axes 129 by the greatest angular rotation among the wheel/hub assemblies in the axle assembly group, while the wheel/hub assemblies 110 of the rearward-most axle 125 in the axle group 106C pivot about their respective axes 129 by the least angular rotation among the wheel/hub assemblies in the group, with the angular rotation of the wheel/hub assemblies of the center axle about their axes 129 being midway between the angular rotations of the wheel/hub assemblies of the other two axes. The angular rotations of the wheel/hub assemblies of axle assembly group 106A exhibit the reverse arrangement. Also, in one or more embodiments the vertical axis 141 of the center axle of axle assembly group 106B is equidistant (in the dimension of elongation of spine beam 108) between the respective vertical axes 141 of the forwardmost axle in group 106C and the rearward-most axle in group 106A, between the respective vertical axes 141 of the center axle in group 106C and the center axle in group 106A, and between the respective vertical axes 141 of the rearward-most axle in group 106C and the forwardmost axle in group 106A.

With the understanding of such geometries, in one or more embodiments, the dimensions and geometries of the hub steering assemblies, the orientation of the control bars 128, and the control linkage between the kingpin/fifth wheel engagement and the control bars 128 are selected so that the rotational axes 131 of the wheel/hub assemblies on the inboard side of the trailer's turn (the upper wheel/hub assemblies in the perspective of FIG. 3B) and on the outboard side of the trailer's turn in both forward axle assembly group 106C and rearward axle assembly group 106A converge at a point P1 along the rotational axis 131A of the wheel/hub assemblies of the center axle of axle assembly group 106B at least when the dimension of elongation of tractor 102 is at a predetermined relative angular rotation with respect to the dimension of elongation of spine beam 108/trailer 107 about axis 111, e.g., when such relative angular rotation corresponds to a commonly expected turn radius for truck 100. Moreover, from the point P1 at which the wheel/hub axles 131 converge at point P1, axes 131 remain convergent on a point on axis 131A as the truck's/trailer's turn radius widens, with the convergence point moving away from the trailer along axis 131A.

In view of this disclosure, it should be understood that the trailer configuration can be varied, for example in the number of axle assemblies in each axle assembly group, in the similarity or difference of the number of axles in each group with respect to the other groups, in the distance or symmetry/asymmetry of the spacings between axle assembly groups, in the inclusion or non-inclusion of hub steering mechanisms in a given axle assembly group, and in the similarity or difference in the angular rotations θ1 of the wheel/hub assemblies on either side of the axles. Further, while mechanical linkages are described in one or more examples herein as effecting the hub steering assemblies, it should be understood that other structures and arrangements may be employed, such as having rotary position sensors disposed operatively between the axle assembly frame and the spine beam so that the sensors detect relative rotation therebetween, one or more controllers that receive the sensors' outputs and that, in response thereto, output instructional signals, and actuators (e.g., hydraulic, pneumatic, or electrical/mechanical linear actuators) disposed operatively between the axle assembly frame and the wheel/hub assembly that may be controlled by the same one or more controllers or by distinct controllers that communicate with those controllers to rotate the wheel/hub assemblies about their vertical axes 129 responsively to such instructions in manners as described herein. Still further, while the presently described embodiments utilize a single hub steering assembly to simultaneously control both wheel/hub assemblies' movement with respect to the axle assembly frame, in other embodiments two or more discrete hub steering assemblies are provided for each axle assembly, one controlling a respective one of the wheel/hub assemblies on the axle assembly. Thus, it should be understood that all such suitable arrangements are encompassed by the present disclosure.

Similarly, it should be understood that other systems may be used to control movement of control bars 128. For example, rather than using a mechanical linkage between the control bars and the kingpin/fifth wheel interface, one or more rotary position sensors may be disposed operatively between the kingpin and the fifth wheel to detect relative rotation therebetween about axis 111. The output signal from these one or more sensors is received by a controller that translates that relative rotational information into movement instructions for the two control bars. The controller transmits such instructions, through a wired or wireless communication, to respective controllers at axle assembly groups 106C and 106A that control operation of a driver, such as a hydraulic or pneumatic piston or a linear actuator, disposed operatively between spine beam 108 and the axle assembly group's control bars, driving them forward or rearward, e.g. as described herein. In such embodiments, and including embodiments utilizing a mechanical linkage such as described above, an actuation system is configured to steer one or more groups of axle assemblies in the trailer, and the amount of rotation induced by the actuation system may be dictated by the amount of relative rotation between the king pin and fifth wheel 196.

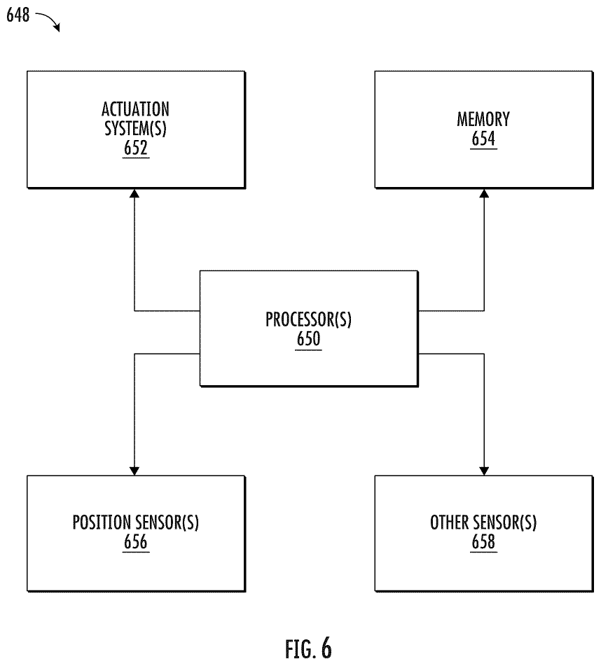

FIG. 6 schematically illustrates various components of a steering assembly 648 for a trailer. Steering assembly 648 may include one or more processors 650, one or more actuation systems 652, a memory 654, one or more position sensors 656, and one or more other sensors 658. Memory 654 may include computer programmable instructions that are configured to, when executed by the processor(s) 650, cause the processor(s) 650 to perform one or more tasks.

Actuation system(s) 652 may include one or more pneumatically powered actuators, one or more hydraulically powered actuators, one or more electrically powered actuators, and/or some other type of actuators. In some embodiments, the actuation system(s) 652 may cause axle assemblies within different groups of axle assemblies to move in desired amounts relative to each other. For example, in reference to FIGS. 1A and 1B, actuation system(s) 652 may cause axle assemblies of first group of axle assemblies 106A to rotate in desired amounts relative to axle assemblies of second group of axle assemblies 106B and/or third group of axle assemblies 106C actuation system(s) 652 may cause movement of an entire group of axle assemblies rather than attempting to separately control movement of each individual axle assembly, and a bar similar to bar 128 may be configured to cause the axle assemblies to rotate in the desired amounts relative to each other within a single group of axle assemblies. However, in other embodiments, actuation system(s) 652 may cause each of the axle assemblies within a single group of axle assemblies to move in the desired amounts relative to each other.

Position sensor(s) 656 may be positioned at various locations within a steering assembly 648 for the trailer such as at one of the axle assemblies, at spine 108, at fifth wheel 196, at truck cab 102, etc., and position sensor(s) 656 may be configured to identify the orientation of a component on which it is positioned. A position of one axle assembly or group of axle assemblies may be detected by a position sensor, and this detected position may be used to control the position of another axle assembly or group of axle assemblies. The detected position may be transmitted electronically to a processor, and the processor may be configured to cause an actuator to move another axle assembly or group of axle assemblies to another position if necessary. However, other sensor(s) 658 may additionally or alternatively be used.

While one or more embodiments of the invention are described above, it should be appreciated by those skilled in the art that various modifications and variations can be made in the present invention without departing from the scope and spirit thereof. For example, alternate embodiments of composite panels in accordance with the present disclosure may have fewer, or more, layers than the number of the discussed embodiments. It is intended that the present invention cover such modifications and variations as come within the scope and spirit of the appended claims and their equivalents.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A trailer comprising:
an elongated body having a dimension of elongation, having a forward end configured to connect to a tractor for pulling the trailer and having a rearward end opposite the forward end;
a plurality of wheeled frames attached to an underside of the elongated body; and
a plurality of wheels attached to each wheeled frame of the plurality of wheeled frames,
wherein the plurality of wheeled frames each define an attachment to the elongated body that is pivotal about a first axis that is generally vertical so that relative rotation between a wheeled frame of the plurality of wheeled frames and the elongated body moves the plurality of wheels attached to that wheeled frame relative to the elongated body about the first axis, and
wherein, at each wheeled frame of the plurality of wheeled frames, a first wheel of the plurality of wheels attached to the wheeled frame is attached to the wheeled frame pivotably about a wheel axis that is generally vertical so that movement of the first wheel about the wheel axis moves the first wheel with respect to the wheeled frame of the plurality of wheeled frames.

2. The trailer as in claim 1, wherein the first axis is offset from the wheel axis.

3. The trailer as in claim 1, wherein
each wheeled frame of the plurality of wheeled frames includes an axle extending transverse to the dimension of elongation of the elongated body, the axle having a first distal end and a second distal end opposite the first distal end,
at least one said first wheel is attached to the first distal end of the axle, and
at least one said first wheel is attached to the second distal end.

4. The trailer as in claim 3, wherein the axle is a solid axle.

5. The trailer as in claim 3, wherein, at each wheeled frame of the plurality of wheeled frames,
the at least one said first wheel that is attached to the first distal end is pivotally attached to the axle at the first distal end about a first said wheel axis, and
the at least one said first wheel that is attached to the second distal end is pivotally attached to the axle at the second distal end about a second said wheel axis.

6. The trailer as in claim 1, wherein the elongated body comprises at least one elongated beam.

7. The trailer as in claim 1, wherein each said frame includes a mechanical linkage attached to the elongated body and to said first wheel at the frame so that the mechanical linkage moves the first wheel about the wheel axis in response to relative movement of the frame and the elongated body about the first axis.

8. The trailer as in claim 7, wherein the mechanical linkage is attached to the elongated body and to each first wheel of a plurality of the first wheels attached to the frame.

9. The trailer as in claim 8, wherein
the mechanical linkage includes a first member, a second member, a third member, a fourth member, and an attachment member,
one end of the first member is attached to the elongated body and an opposite end of the first member is attached to the attachment member,
one end of the second member is attached to the elongated body and an opposite end of the second member is attached to the attachment member,
one end of the third member is attached to a first said first wheel and an opposite end of the third member is attached to the attachment member, and
one end of the fourth member is attached to a second said first wheel assembly and an opposite end of the fourth member is attached to the attachment member.

10. The trailer as in claim 1, wherein the attachment is a bearing between the elongated body and the frame.

11. The trailer as in claim 1, including a rigid member attached to a plurality of the frames so that movement of the rigid member in a direction in the dimension of elongation simultaneously rotates each of the plurality of frames with respect to the elongated body about said first axis.

12. The trailer as in claim 11, wherein the rigid member is attached to each of the plurality of frames at a position on the frame that is offset from the first axis of the frame, and wherein the position on each said frame is offset from its first axis by a distance that is different from the distance the position on each other frame of the plurality of frames is offset from the first axis of the frame.

13. A method of steering a trailer comprising the steps of:
providing the trailer, the trailer having
an elongated body having a dimension of elongation, having a forward end configured to connect to a tractor for pulling the trailer and having a rearward end opposite the forward end,
a plurality of wheeled frames attached to an underside of the elongated body, and
at each wheeled frame of the plurality of wheeled frames, a plurality of wheels attached to the wheeled frame, with each of the plurality of wheels including a first wheel;
rotating a wheeled frame of the plurality of wheeled frames relative to the elongated body about a first axis that is generally vertical so that the plurality of wheels moves relative to the elongated body about the first axis; and
at each said wheeled frame, pivoting each said first wheel of the plurality wheels attached to said wheeled frame about a wheel axis that is generally vertical, so that movement of the first wheel about the wheel axis moves the first wheel with respect to the wheeled frame, simultaneously with the rotating of the wheeled frame relative to the elongated body.

14. A trailer comprising:
a body;
a plurality of axle assemblies attached to an underside of the body; and
a plurality of wheels attached to each axle assembly of the plurality of axle assemblies,
wherein a first axle assembly of the plurality of axle assemblies comprises a first axle defining a longitudinal axis, the longitudinal axis of the first axle extending generally horizontally, wherein the first axle assembly permits rotation of the first axle relative to the body and about a generally vertical axle axis, and
wherein a first wheel of the plurality of wheels attached to the first axle assembly is pivotably attached to the first axle, and wherein the first wheel is rotatable relative to the first axle about a generally vertical wheel axis.

15. The trailer as in claim 14, wherein the first axle assembly includes a mechanical linkage, and wherein the mechanical linkage is attached to the body and to the first wheel.

16. The trailer as in claim 15, wherein the first axle assembly is rotatable relative to the body, wherein rotation of the first axle assembly results in an identical amount of rotation of the first axle, and wherein the rotation of the first axle assembly results in an amount of rotation for the first wheel that is different relative to the amount of rotation for the first axle.

17. The trailer as in claim 16, wherein the rotation of the first axle assembly results in the amount of rotation for the first wheel being larger than the amount of rotation for the first axle.

18. The trailer as in claim 15, wherein the first axle assembly is rotatable relative to the body, and wherein rotation of the first axle assembly relative to the body causes movement of the mechanical linkage, thereby causing the first wheel to rotate about the wheel axis.

19. The trailer as in claim 18, wherein
the mechanical linkage includes a first member, a second member, a third member, a fourth member, and an attachment member,
one end of the first member is attached to the body and an opposite end of the first member is attached to the attachment member,
one end of the second member is attached to the body and an opposite end of the second member is attached to the attachment member,
one end of the third member is attached to the first wheel and an opposite end of the third member is attached to the attachment member, and
one end of the fourth member is attached to a second wheel and an opposite end of the fourth member is attached to the attachment member.

20. The trailer as in claim 14, wherein the axle is a solid axle.
